(19) United States
(12) Patent Application Publication
(10) Pub. No.: US 2010/0188778 A1
(43) Pub. Date: Jul. 29, 2010

(54) Disk Drive Assembly Having Flexible Support for Flexible Printed Circuit Board

(76) Inventor: Joseph T. Castagna, San Jose, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/362,391

(22) Filed: Jan. 29, 2009

(51) Int. Cl. G11B 5/48

(52) U.S. Cl. 360/245.9; G9B/5.147

(57) ABSTRACT

A disk drive assembly includes a movable assembly having a mounting arm, a stationary electronics module, a flexible printed circuit board (PCB) electrically connecting the movable assembly to the stationary electronics module, and a flexible support sandwiched between the flexible PCB and the mounting arm. The flexible support is attached to the mounting arm and the flexible PCB, and extends past the mounting arm of the movable assembly. The flexible support is flexible enough to flex with the flexible PCB but has sufficient rigidity so that an exit point and an exit angle of the flexible PCB can vary during movement of the movable assembly. In addition, the flexible PCB is attached to the flexible support through an adhesive layer that damps vibrations in the flexible PCB.

### BACKGROUND OF THE INVENTION

1. Field of the Invention

Embodiments of the present invention relate generally to magnetic disk drives and, more particularly, to a magnetic disk drive assembly having a flexible support for a flexible printed circuit board.

2. Description of the Related Art

Magnetic disk drives are commonly used in computer systems since such drives can inexpensively store large quantities of non-volatile data for quick access. Magnetic disk drives generally include one or more rotatable magnetic media disks having concentric data tracks defined for storing data, a magnetic read/write transducer for reading data from and/or writing data to the various data tracks, a slider mechanism for supporting the read/write transducer in close proximity to the data tracks, and a rotatable positioning actuator coupled to the transducer/slider combination for moving the read/write transducer across the media to the desired data track and maintaining the transducer over the data track center line during a read or write operation. An actuator flex cable, also referred to as a flexible printed circuit board (flex PCB), provides the electrical contact between the read/write transducer disposed on the slider mechanism and disk drive electronics external to the positioning actuator, and is typically comprised of a plurality of electrical conductors encapsulated within an insulating material.

In operation, the flex PCB carries electrical signals to and from the positioning actuator via a flexible connection, thereby allowing the positioning actuator to move freely during operation of the disk drive. The radial motion of the actuator allows the read/write transducer to access data tracks on the disk surfaces located at any radial position on the disk, from the inside diameter to the outside diameter. A preferred method of fixing the flex PCB between the external electronics and the positioning actuator is to form the flex PCB in a loop to produce minimal constraint on the movement of the positioning actuator.

Disk drive performance as measured by track misregistration (TMR) is degraded by vibration of components within the disk drive, particularly the flex PCB loop connecting the positioning actuator with the external electronics. For example, radial movement of the positioning actuator to position the read/write transducer to a selected track on the disk produces oscillations in the flex PCB at the relatively low frequencies known to significantly affect the position of the read/write transducer, i.e., frequencies less than approximately 1000 Hz. In addition, the acceleration and deceleration of the positioning actuator when moving the read/write transducer to a selected track further excites low-frequency resonances in the flex PCB, increasing stabilization time of the read/write transducer and eroding drive performance.

FIG. 1 is a graph of read/write transducer position of a disk drive with respect to a selected track versus time. The oscillatory nature of the read/write transducer position relative to the intended location indicates that the positioning actuator is “ringing” with a low-frequency resonance after arriving at a desired track, in this example at approximately 320 Hz. For this disk, a 320 Hz resonance has been measured directly on the connecting loop of the flex PCB, which corresponds to the frequency of the resonance detected in the positioning actuator. Methods are known in the art for reducing and/or damping the vibration of the flex PCB. However, such solutions involve designs solutions that are complex, difficult to manufacture, and/or require costly materials.

In light of the above, there is a need in the art for a means to minimize the effect of flexible PCB vibration that occurs during operation of a disk drive.

### SUMMARY OF THE INVENTION

A disk drive assembly according to one or more embodiments of the invention includes a movable assembly having a read/write head and a mounting arm, a stationary electronics module, a flexible printed circuit board (PCB) electrically connecting the movable assembly to the stationary electronics module, and a flexible support attached to the flexible PCB and the mounting arm. The flexible support extends past the mounting arm of the movable assembly and is flexible enough to flex with the flexible PCB but has sufficient rigidity so that an exit point and an exit angle of the flexible PCB can vary during movement of the movable assembly.

A disk drive assembly according a first embodiment includes a movable assembly having a mounting arm, a stationary electronics module, a flexible PCB electrically connecting the movable assembly to the stationary electronics module, and a flexible support having a first portion sandwiched between the flexible PCB and the mounting arm and a second portion attached to the flexible PCB that extends past the end of the mounting arm, wherein during movement of the movable assembly, the second portion of the flexible support flexes and reduces the amount of flex of the flexible PCB attached thereto.

A disk drive assembly according a second embodiment includes a movable assembly having a mounting arm, a stationary electronics module, a flexible PCB electrically connecting the movable assembly to the stationary electronics module, and a flexible support sandwiched between the flexible PCB and the mounting arm and attached to the flexible PCB through an adhesive layer that damps vibrations in the flexible PCB.

A disk drive assembly according a third embodiment includes a movable assembly having a mounting arm, a stationary electronics module, a flexible PCB electrically connecting the movable assembly to the stationary electronics module, and a flexible support having a first portion that is sandwiched between the flexible PCB and the mounting arm and a second portion attached to the flexible PCB that extends past the end of the mounting arm, wherein the second portion of the flexible support has a shape that is non-uniform along the length of the flexible PCB, so that the stiffness characteristics of the flexible PCB and flexible support combination differs along the length thereof.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a graph of read/write transducer position with respect to a selected track versus time.

FIG. 2 is a plan view of a disk drive including a vibration-damping system according to an embodiment of the invention.

FIG. 3 illustrates a partial plan view of an actuator assembly, a J-block, and a vibration-damping system according to an embodiment of the invention.

FIG. 4A illustrates a flexible PCB of a disk drive exiting a J-block in a manner known in the art.

FIG. 4B illustrates a flexible PCB of a disk drive having a rigid support for the flexible PCB in a manner known in the art.

FIG. 4C illustrates a flexible PCB of a disk drive having a flexible support for the flexible PCB according to an embodiment of the invention.

FIG. 5 is a schematic cross-sectional view of a vibration-damping system, where the vibration-damping system has a rectangular cross section, according to an embodiment of the invention.

FIGS. 6A, 6B are graphs showing the power spectrum of vibrations occurring at a read/write transducer as it flies over a selected track of a magnetic disk.

FIG. 7A illustrates a partial side-view of a flexible stiffener having a uniform geometry, according to an embodiment of the invention.

FIGS. 7B, 7C illustrate partial side-views of flexible stiffeners having non-uniform geometries, according to embodiments of the invention.

FIG. 8 illustrates a partial plan view of an actuator assembly, a J-block, and a vibration-damping system according to another embodiment of the invention.

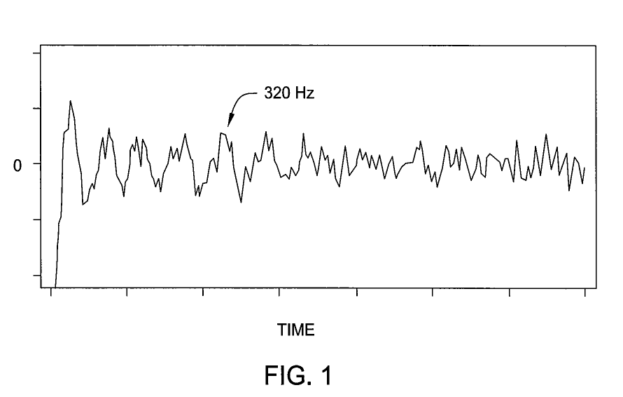

For clarity, identical reference numbers have been used, where applicable, to designate identical elements that are common between figures. It is contemplated that features of one embodiment may be incorporated in other embodiments without further recitation.

### DETAILED DESCRIPTION

Embodiments of the invention contemplate a vibration-damping system for a disk drive that reduces vibration of a flexible printed circuit board (PCB) of the disk drive. The vibration-damping system includes a flexible stiffener attached to a flexible PCB via a viscoelastic adhesive layer to form a layered structure disposed at an attachment point of the connecting loop of the flexible PCB. The respective thicknesses of the flexible PCB, the viscoelastic adhesive layer, and the flexible stiffener provide the layered structure with an overall stiffness that maintains the flexible PCB oriented near an optimal exit angle from the flexible PCB attachment point throughout the range of motion of the flexible PCB, thereby reducing mechanical coupling between the flexible PCB and the actuator assembly of the disk drive. In addition, the viscoelastic adhesive layer damps resonances present in the flexible PCB. The damping treatment can be easily applied to the flexible PCB without significantly affecting cost or complexity of manufacturing the disk drive.

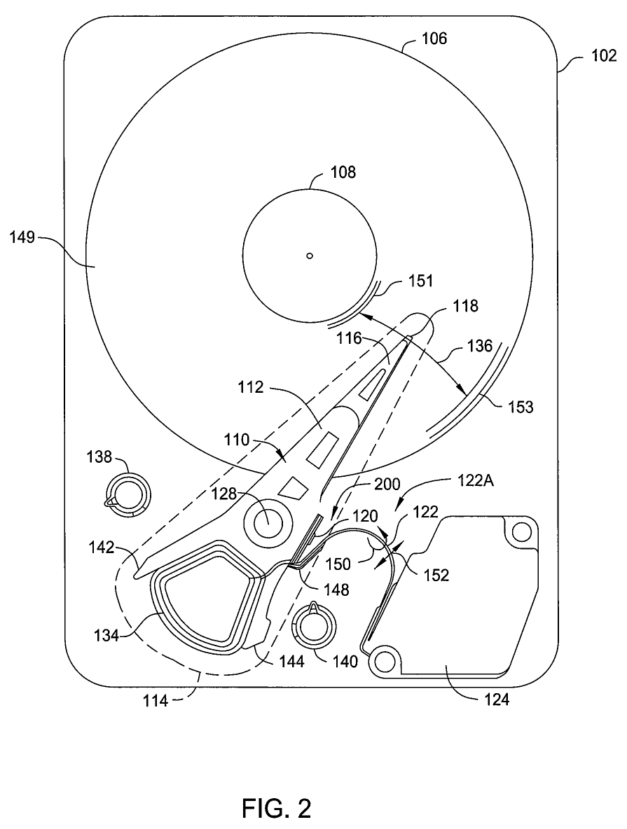

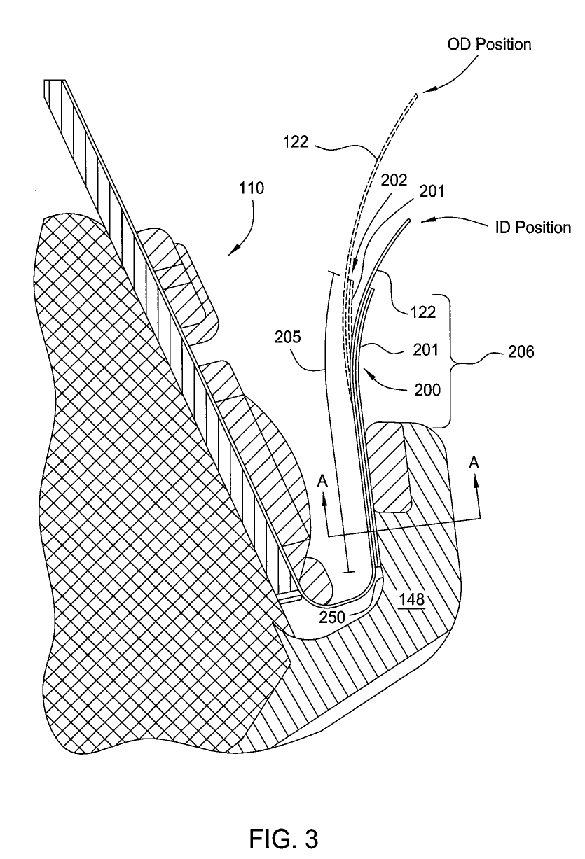

FIG. 2 is a plan view of a disk drive 100 including a vibration-damping system 200 according to embodiments of the invention. Vibration-damping system 200 is shown in greater detail in FIG. 3. For clarity, disk drive 100 is illustrated in FIG. 2 without a top cover. Disk drive 100 includes a housing 102, one or more magnetic disks 106, a spindle 108, an actuator assembly 110, a flexible PCB 122, and an electronics bracket 124. On the surface of magnetic disks 106, digital data can be stored as magnetic signals formed along concentric tracks. Both sides of magnetic disks 106 may have such data stored thereon, and those skilled in the art will recognize that any number of such magnetic disks 106 may be included in the disk drive 100. Magnetic disks 106 are mounted to spindle 108, which is mechanically coupled to a spindle motor (not shown) that rotates magnetic disks 106 within housing 102.

Actuator assembly 110, also referred to as a head stack assembly, includes an actuator arm 112 integrally connected with an E-block, or comb 114, and a suspension assembly 116. Suspension assembly 116 includes a slider/transducer assembly 118 at its distal end configured for movement across the surface of magnetic disk 106. While only one suspension assembly 116 is illustrated in FIG. 2, those skilled in the art will appreciate that disk drive 100 may include a suspension assembly 116 for each side of each magnetic disk 106. Actuator assembly 110 is mounted on a pivot bearing for rotational movement about a pivot point 128 to position slider/transducer assembly 118 over a selected data track on magnetic disk 106. The pivotal motion of actuator assembly 110 and suspension assembly 116 across the surface 149 of magnetic disk 106 is indicated by arrow 136. The motion of actuator assembly 110 is limited by contact between stops 138, 140, and rearward extensions or VCM coil support arms 142, 144, respectively. The limits of the actuator assembly rotation define the inner diameter (ID) track 151 and the outer diameter (OD) track 153 on the disk surface 149 that may be accessed by the slider transducer assembly 118.

Flexible PCB 122 carries signals between an amplifier chip 120 and external signal processing electronics via a connector pin assembly (not shown) attached to disk housing 102. Flexible PCB 122 leads from the amplifier chip 120 to electronics bracket 124 and forms a connecting loop 122A that is fixed at each end, as shown. One end of connecting loop 122A is fixed to actuator assembly 110 at a J-shaped fixture, or J-block, 148, and the other end is attached to electronics bracket 124. Electronics bracket 124 directs flexible PCB 122 to a connector port (not shown) for connection to disk drive electronics external to housing 102. J-block 148 provides mechanical support for flexible PCB 122 and directs flexible PCB 122 to form connecting loop 122A between actuator assembly 110 and electronics bracket 124. In the embodiment illustrated in FIG. 2, J-block 148 is also the connection point for layered vibration-damping system 200. Connecting loop 122A provides mechanical isolation for actuator assembly 110, allowing rotary motion of actuator assembly 110 during operation of disk drive 100 with minimal mechanical constraint.

In operation, movement of the actuator assembly 110 to position slider/transducer assembly 118 over a selected track on magnetic disk 106 generates oscillations in flexible PCB 122 due to the inertial and elastic properties of the material making up flexible PCB 122. Such oscillations may be torsional as well as lateral, as indicated by arrows 150 and 152, respectively. Mechanical coupling between flexible PCB 122 and slider/transducer assembly 118 translates the resonances of flexible PCB 122 to slider/transducer assembly 118, thereby producing unwanted movement of slider/transducer assembly 118 away from the intended position of slider/transducer assembly 118.

To minimize the coupling of resonances initiated at flexible PCB 122 to slider/transducer assembly 118, a series of experiments may be performed to tune the relative positions and orientations of connecting loop 122A, J-block 148, and the attachment location for flexible PCB 122 on electronics bracket 124. Such experiments involve adjusting the exit angle of connecting loop 122A from both J-block 148 and electronics bracket 124 and/or modifying the position of electronics bracket 124, then characterizing the resonances that occur on connecting loop 122A when actuator assembly 110 is operated normally. Such experiments, which can be readily devised by one of skill in the art, produce an optimal configuration for the relative positions and orientations of connecting loop 122A, J-block 148, and the attachment location for flexible PCB 122 on electronics bracket 124, so that minimal coupling of flex PCB-initiated resonance to slider/transducer assembly 118 takes place.

As noted above, an optimal configuration of connecting loop 122A from J-block 148 and electronics bracket 124 for minimal coupling of resonances to actuator assembly 110 may be determined experimentally. However, the exit angle of connecting loop 122A varies as actuator assembly 110 moves through its normal range of motion between inner diameter track 151 and the outer diameter track 153. Consequently, connecting loop 122A can be positioned with an optimal exit angle from J-block 148 and electronics bracket 124 only through a limited portion of the stroke of actuator assembly 110. Thus, mechanical coupling between flexible PCB 122 and slider/transducer assembly 118 can be minimized only through a limited portion of the stroke of actuator assembly 110, meaning that a trade-off exists between having minimal coupling to actuator assembly 110 in the inner diameter (ID) and outer diameter (OD) positions.

Embodiments of the invention contemplate a vibration damping system that allows both the exit location and angle of flexible PCB 122 to vary slightly as actuator assembly 110 moves through its normal range of motion. In this way, mechanical coupling between flexible PCB 122 and actuator assembly 110 can be reduced throughout the range of motion of actuator assembly 110.

FIG. 3 illustrates a partial plan view of actuator assembly 110, J-block 148, and vibration-damping system 200, according to an embodiment of the invention. Vibration-damping system 200 includes a flexible stiffener 201 attached to flexible PCB 122 via a viscoelastic adhesive layer 202 to form a layered structure. Vibration-damping system 200 is illustrated as being disposed at the attachment point of connecting loop 122A to J-block 148 of flexible PCB 122.

Flexible stiffener 201 is a support member attached to flexible PCB 122 that is relatively flexible in the plane of motion of actuator assembly 110, and bends easily in this plane. In addition, flexible stiffener 201 is relatively rigid and resistant to bending out of this plane. Flexible stiffener 201 may be a polymer or other elastic material having a relatively low stiffness properties that are only slightly greater than the stiffness of flexible PCB 122. Examples of materials suitable for use as flexible stiffener 201 include Kapton®, manufactured by Dupont, a polyimide film. Other generic versions of polyimide film may be applied with equal effect. Unlike rigid supports known in the art that are used to prevent flexible PCBs in disk drives from torsional and/or out-of-plane bending, flexible stiffener 201 is configured to significantly deflect as actuator assembly 110 pivots about pivot point 128 during operation and J-block 148 moves with respect to electronics bracket 124. The length and stiffness of flexible stiffener 201 may be used as tuning parameters when configuring flexible PCB 122 for minimal coupling to actuator assembly 110.

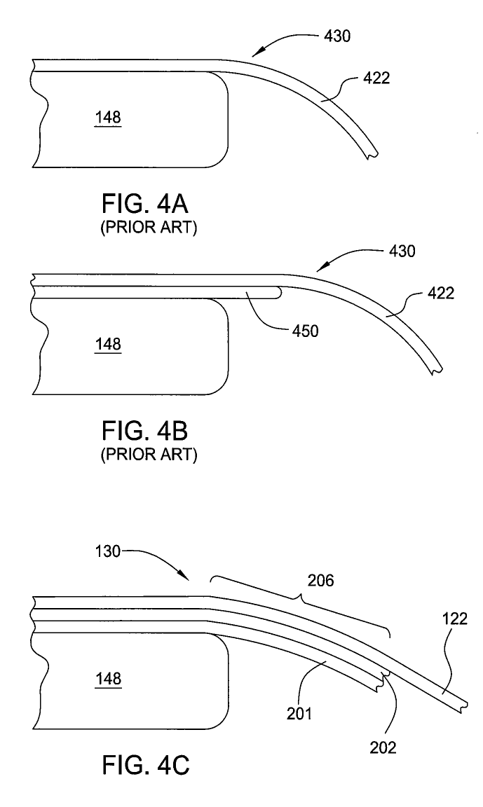

FIG. 4A illustrates a flexible PCB 422 of a disk drive exiting a J-block 148 in a manner known in the art. As actuator assembly 110 pivots and J-block 148 rotates with respect to PCB 422, the effective exit point 430 of PCB 422 remains substantially stationary with respect to J-block 148. FIG. 4B illustrates a flexible PCB 422 exiting a J-block 448 having a rigid PCB support 450 in a manner known in the art, wherein the term “rigid” is herein defined as undergoing no significant deflection when subjected to the loads present in a disk drive PCB during normal operation of the disk drive. Rigid PCB support 450 provides a means by which the effective exit point 431 of PCB 422 from J-block 448 may be positioned as desired to reduce mechanical coupling between PCB 422 and the actuator assembly containing J-block 448. However, as the actuator assembly containing J-block 448 pivots and J-block 448 rotates with respect to PCB 422, the effective exit point 431 of PCB 422 remains substantially stationary with respect to J-block 448.

FIG. 4C illustrates a flexible PCB 122 of disk drive 100 exiting J-block 148 according to an embodiment of the invention. As actuator assembly 110 pivots and J-block 148 rotates with respect to PCB 122, the effective exit point 130 of PCB 122 varies with respect to J-block 148 as a function of the length and flexibility of flexible stiffener 201 in vibration-damping system 200. Thus, the stiffness of flexible stiffener 201 and the distance 206 that flexible stiffener 201 extends from J-block 148 may be used as tuning parameters to minimize vibration coupling throughout the range of motion of actuator assembly 110. The appropriate length 205 of flexible stiffener 201 and distance 206 that flexible stiffener 201 extends from J-block 148 is selected such that the optimal exit angle for flexible PCB 122 can be achieved for the entire range of motion of actuator assembly 110.

Referring back to FIG. 3, viscoelastic adhesive layer 202 includes an adhesive material for bonding flexible stiffener 201 to flexible PCB 122. The adhesive material is selected to have significant damping properties in the range of frequencies that are intended to be damped by vibration-damping system 200 at the temperatures present during operation of disk drive 100. Examples of materials suitable for use in viscoelastic adhesive layer 202 include viscoelastic damping polymers, such as 3M™ Viscoelastic Damping Polymers Type 110 or 112. Other appropriate materials may be used that meet the outgassing and cleanliness requirements necessary for hard drives. The damping properties of viscoelastic adhesive layer 202 may be tailored so that resonances in the requisite frequency range are significantly reduced. Both the thickness and the inherent stiffness properties of the material used for viscoelastic adhesive layer 202 determine the frequency range that is damped by viscoelastic adhesive layer 202. In addition, because most vibration-damping materials vary in performance as a function of temperature, viscoelastic adhesive layer 202 is also selected based on the anticipated operating temperature at which vibration damping is desired. Upon reading the disclosure presented herein, one of skill in the art can readily select an appropriate viscoelastic material for viscoelastic adhesive layer 202 to damp resonances in a specific frequency range originating in flexible PCB 122.

As illustrated in FIG. 3, vibration-damping system 200 is a layered structure that attaches flexible PCB 122 to surface 250 of J-block 148. Because vibration-damping system 200 is designed to be slightly more rigid than flexible PCB 122 in the plane of motion of actuator assembly 110, vibration-damping system 200 influences the effective exit point and exit angle of flexible PCB 122 as actuator assembly 110 rotates between the ID position and the OD position. Consequently, when vibration-damping system 200 is configured with appropriate stiffness properties, vibration-damping system 200 minimizes vibration coupling throughout the range of motion of actuator assembly 110. By way of illustration, FIG. 3 shows the position of flexible PCB 122 and vibration-damping system 200 when actuator assembly 110 is in the ID position and in the OD position.

Vibration-damping system 200 also serves two other purposes. First, viscoelastic adhesive layer 202 damps resonances originating in flexible PCB 122. Because such resonances have been shown to result in the most serious unwanted displacement of actuator assembly 110, such damping substantially improves disk drive performance. Second, vibration-damping system 200 helps prevent flexible PCB 122 from bending out of the plane of motion of actuator assembly 110. Vibration-damping system 200 holds actuator assembly 110 in said plane due to the rigidity of vibration-damping system 200 with respect to bending out of said plane.

Flexible PCB 122 is slightly under tension when actuator assembly 110 is in either the ID or the OD position. In this way, viscoelastic adhesive layer 202 is under compression at all times and there is no tendency for flexible PCB 122 to separate from flexible stiffener 201.

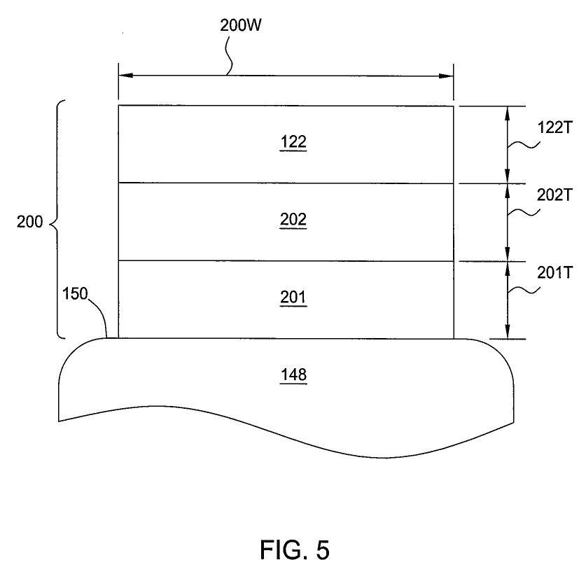

In one embodiment, vibration-damping system 200 is rectangular in cross section, to better promote flexibility in the plane of motion of actuator assembly 110 and resistance to bending out of said plane. FIG. 5 is a schematic cross-sectional view of vibration-damping system 200 taken at section A-A in FIG. 3, where vibration-damping system 200 has a rectangular cross section, according to an embodiment of the invention. As shown, in such an embodiment, vibration-damping system 200 is a layered structure that includes flexible stiffener 201, viscoelastic adhesive layer 202, and flexible PCB 122. All three elements of the layered structure are rectangular in cross section. Further, each of said rectangular cross sections may have a very high aspect ratio. To with, thicknesses 122T, 202T, and 201T of flexible PCB 122, viscoelastic adhesive layer 202, and flexible stiffener 201, respectively, may be approximately an order of magnitude smaller than the width 200W of vibration-damping system 200. Consequently, vibration-damping system 200 may be a ribbon-like structure having high flexibility in one plane and significant rigidity or resistance to bending in any orthogonal plane.

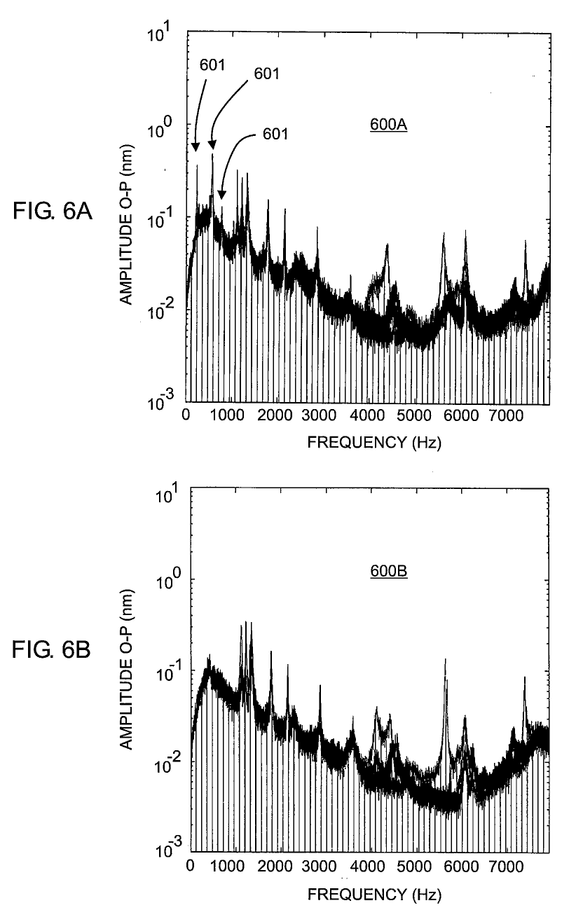

In one embodiment, resonances produced by flexible PCB 122 having frequencies of approximately 1000 Hz and below are damped by the modification of flexible PCB 122 with vibration-damping system 200. In such an embodiment, flexible PCB 122 has a thickness 122T of 0.05 mm and is formed of outside polyimide layers encasing thin copper electrical traces, viscoelastic adhesive layer 202 has a thickness 202T of 0.05 mm and is formed of 3M™ Viscoelastic Damping Polymers Type 112, and flexible stiffener 201 has a thickness 201T of 0.05 mm and length 205 of 6 mm, and is formed of polyimide film. Flexible stiffener 201 extends from J-block 148 a distance 206 of 3.5 mm. FIG. 6A is graph 600A showing the power spectrum of non-repeatable vibrations occurring at a read/write transducer as it flies over a selected track of a magnetic disk. At 1000 Hz and below, several resonances 601 are detected. The frequencies of resonances 601 have been demonstrated to correspond to the frequencies of resonances measured directly on flexible PCB 122. Significantly, resonances 601 are in the low frequencies demonstrated to cause substantial and unwanted displacement of actuator assembly 110 during operation of disk drive 100. FIG. 6B is graph 600B showing the power spectrum of vibrations occurring under the same conditions as graph 600A, except that flexible PCB 122 is modified with vibration-damping system 200 having the thicknesses 122T, 202T, 201T, length 205, and materials described above. As shown in FIG. 6B, the addition of vibration-damping system 200 has removed resonances 601 from the power spectrum of vibrations occurring at a read/write transducer without noticeably exacerbating the resonances at any other frequencies.

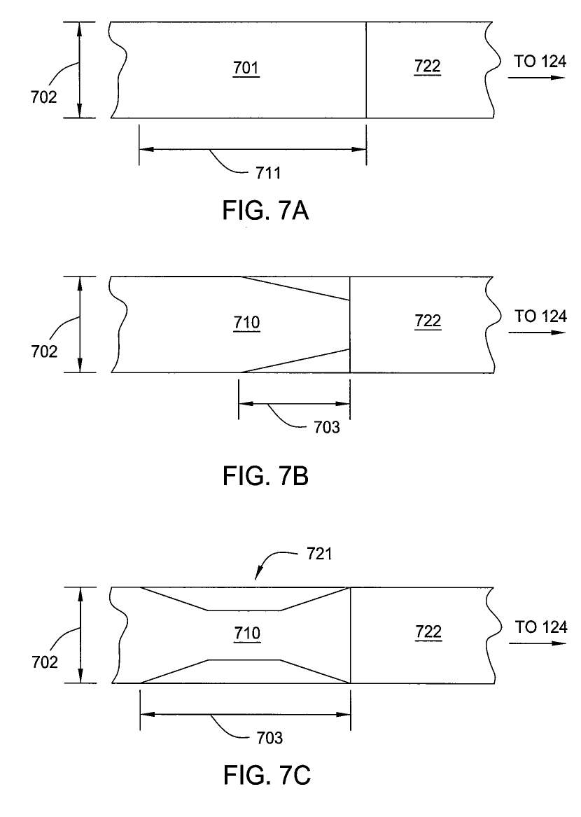

The flexibility of a flexible stiffener may be varied across its length by forming the flexible stiffener with a non-uniform geometry. FIG. 7A illustrates a partial side-view of a flexible stiffener 701 having a uniform geometry and attached to flexible PCB 122, according to an embodiment of the invention. Flexible stiffener 701 is a uniform rectangle along the entire length 711 thereof, and therefore is a support member having a uniform stiffness along length 711. FIG. 7B illustrates a partial side-view of a flexible stiffener 710 having a non-uniform geometry, according to an embodiment of the invention. In such an embodiment, flexible stiffener 701 is trapezoidal, triangular, or otherwise varies in height 702 or thickness (into page) across a portion of its length 703. An advantage of this embodiment is that the stiffness of flexible stiffener 710 and, hence, any vibration-damping system that includes flexible stiffener 710, may be fine-tuned to align a flexible PCB with an optimal exit angle. FIG. 7C illustrates a schematic side-view of a flexible stiffener 720 having a non-uniform geometry, according to an embodiment of the invention. Similar to flexible stiffener 710, flexible stiffener 720 also varies in height 702 across a portion of its length 703. However, flexible stiffener 720 has a region of minimal stiffness in a center portion 721 of flexible stiffener 720, rather than at an end. Other configurations of flexible stiffeners having non-uniform geometries are also contemplated.

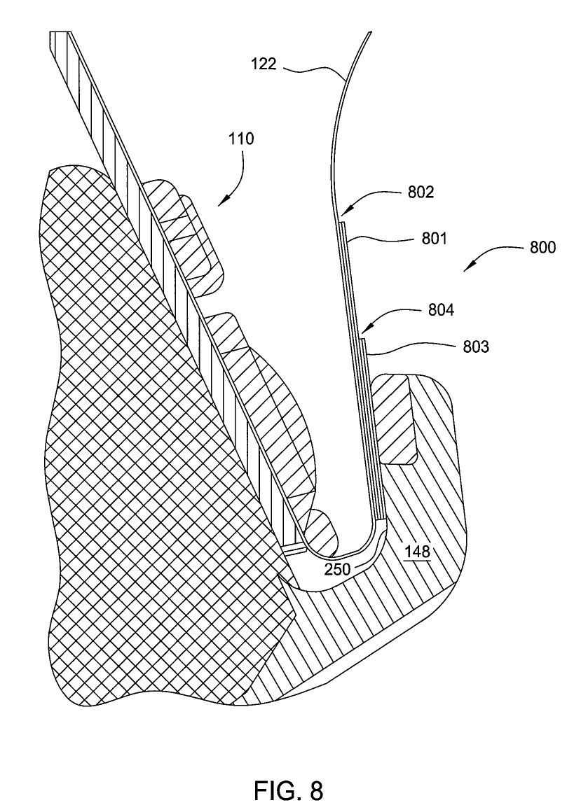

FIG. 8 illustrates a partial plan view of an actuator assembly 110, a J-block 148, and a vibration-damping system 800 according to another embodiment of the invention. In this embodiment, vibration-damping system 800 includes a first flexible stiffener 801 attached to flexible PCB 122 via a first viscoelastic adhesive layer 802 and a second flexible stiffener 803 attached to the first flexible stiffener 801 via a second viscoelastic adhesive layer 804 to form a layered structure. As shown, the distance that flexible stiffener 803 extends from J-block 148 is shorter than the distance that flexible stiffener 801 extends from J-block 148 by about two-thirds.

Examples of materials suitable for use as first and second flexible stiffeners 801, 803 include Kapton®, manufactured by Dupont, a polyimide film. Other generic versions of polyimide film may be applied with equal effect. The materials used in first and second viscoelastic adhesive layers 802, 804 include viscoelastic damping polymers, such as 3M™ Viscoelastic Damping Polymers or other appropriate materials that meet the outgassing and cleanliness requirements necessary for hard drives, with different characteristics. The first viscoelastic adhesive layer 802 employs a viscoelastic damping polymer that has been optimized for higher temperatures relative to the second viscoelastic adhesive layer 804, and the second viscoelastic adhesive layer 804 employs a viscoelastic damping polymer that has been optimized for lower temperatures relative to the first viscoelastic adhesive layer 802. With this configuration, the effective temperature range of vibration-damping system 800 can be increased.

While the foregoing is directed to embodiments of the present invention, other and further embodiments of the invention may be devised without departing from the basic scope thereof, and the scope thereof is determined by the claims that follow.

I claim:

1. A disk drive assembly, comprising:
a movable assembly having a mounting arm;
a stationary electronics module;
a flexible printed circuit board (PCB) electrically connecting the movable assembly to the stationary electronics module; and
a flexible support having a first portion that is sandwiched between the flexible PCB and the mounting arm and a second portion attached to the flexible PCB that extends past the end of the mounting arm,
wherein, during movement of the movable assembly, the second portion of the flexible support flexes and reduces the amount of flex of the flexible PCB attached thereto.

2. The disk drive assembly according to claim 1, further comprising an adhesive layer between the flexible PCB and the flexible support for damping vibrations in the flexible PCB.

3. The disk drive assembly according to claim 1, wherein the flexible support includes a first polyimide film attached to the flexible PCB via a first adhesive layer and a second polyimide film attached to the first polyimide film via a second adhesive layer.

4. The disk drive assembly according to claim 3, wherein a length of the first polyimide film is longer than a length of the second polyimide film.

5. The disk drive assembly according to claim 1, wherein the movable assembly includes a read/write head and moves the read/write head between inner and outer diameters of a magnetic disk, and wherein an exit point of the flexible PCB continuously varies as the read/write head is moved between the inner diameter and the outer diameter.

6. The disk drive assembly according to claim 5, wherein an exit angle of the flexible PCB continuously varies as the read/write head is moved between the inner diameter and the outer diameter.

7. The disk drive assembly according to claim 1, wherein the flexible support is made of flexible material but has sufficient rigidity so that, when the flexible PCB is attached thereto, the stiffness of the flexible PCB and flexible support combination is greater than the stiffness of the flexible PCB by itself.

8. A disk drive assembly, comprising:
a movable assembly having a mounting arm;
a stationary electronics module;
a flexible printed circuit board (PCB) electrically connecting the movable assembly to the stationary electronics module; and
a flexible support sandwiched between the flexible PCB and the mounting arm and attached to the flexible PCB through an adhesive layer that damps vibrations in the flexible PCB.

9. The disk drive assembly according to claim 8, wherein the adhesive layer is a viscoelastic adhesive layer.

10. The disk drive assembly according to claim 8, wherein the adhesive layer is under compression during movement of the movable assembly.

11. The disk drive assembly according to claim 10, wherein a portion of the flexible support has a shape that is non-uniform along the length of the flexible PCB.

12. The disk drive assembly according to claim 10, widths of the flexible PCB and the flexible support are approximately equal.

13. The disk drive assembly according to claim 8, wherein the flexible PCB, the adhesive layer, and the flexible support form a three-layer structure, each layer having a width that is substantially larger than its thickness.

14. The disk drive assembly according to claim 13, wherein each layer of the three-layer structure has a width that is at least an order of magnitude larger than its thickness.

15. A disk drive assembly, comprising:
a movable assembly having a mounting arm;
a stationary electronics module;
a flexible printed circuit board (PCB) electrically connecting the movable assembly to the stationary electronics module; and
a flexible support having a first portion that is sandwiched between the flexible PCB and the mounting arm and a second portion attached to the flexible PCB that extends past the end of the mounting arm,
wherein the second portion of the flexible support has a shape that is non-uniform along the length of the flexible PCB, so that the stiffness characteristics of the flexible PCB and flexible support combination differs along the length thereof.

16. The disk drive assembly according to claim 15, further comprising an adhesive layer between the flexible PCB and the flexible support for damping vibrations in the flexible PCB.

17. The disk drive assembly according to claim 15, wherein the flexible support includes a first polyimide film attached to the flexible PCB via a first adhesive layer and a second polyimide film having a shorter length than the first polyimide film, attached to the first polyimide film via a second adhesive layer.

18. The disk drive assembly according to claim 15, wherein the shape of the second portion of the flexible support has symmetry with respect to a center line of the flexible PCB.

19. The disk drive assembly according to claim 18, wherein the width of the second portion of the flexible support is tapered.

20. The disk drive assembly according to claim 18, wherein the second portion of the flexible support has a constant width section in between a pair of tapered sections.
